(19) United States
(12) Patent Application Publication
(10) Pub. No.: US 2011/0038082 A1
(43) Pub. Date: Feb. 17, 2011

(54) COMBINED CMP AND ETCH PLANARIZATION

(75) Inventors: Zhaohui Fan, Fremont, CA (US); David S. Kuo, Palo Alto, CA (US); Kim Yang Lee, Fremont, CA (US)

Correspondence Address: SEAGATE TECHNOLOGY Outside Counsel Dergosits;& Noah LLP, Three Embarcadero Center, Suite 410, San Francisco, CA, 94111, US

(73) Assignee: Seagate Technology LLC, Scotts Valley, CA (US)

(21) Appl. No.: 12/540,185

(22) Filed: Aug. 12, 2009

(51) Int. Cl. G11B 5/74; B05D 5/12

(52) U.S. Cl. 360/131; 427/127; G9B/5.289

(57) ABSTRACT

A magnetic device having a magnetic feature, the magnetic feature including magnetic portions, a stop layer portion on each magnetic portion, and a region of non-magnetic material adjacent to the magnetic portions and the stop layer portions, where the stop layer portions define planar upper boundaries for the magnetic portions and an endpoint in planarization of the magnetic feature.

### FIELD OF THE INVENTION

The present invention relates to magnetic devices having magnetic features and to methods of fabricating the magnetic features. In particular, the present invention relates to magnetic devices having magnetic features for use in magnetic recorders and magnetic random access memory cells, and to methods of fabricating the magnetic features with combined chemical-mechanical polishing (CMP) and etching planarization.

### BACKGROUND OF THE INVENTION

Magnetic storage systems, referred to herein as magnetic recorders, are used to store data on magnetic storage media through the use of a transducer that writes and reads magnetic data on the media. For example, a disk magnetic recorder is generally adapted to work with one or more magnetic recording disks that are coaxially mounted on a spindle motor of the recorder for high-speed rotation. As the disks rotate, one or more transducers, i.e., read and/or write heads, are moved across the surfaces of the disks by an actuator assembly to read and write digital information on the disks.

Given the general desire to store ever-increasing amounts of digital information, designers and manufacturers of magnetic recorders are continually attempting to increase the magnetic volume of magnetic storage media. One such method has involved the use of bit-patterned media (BPM). BPM is patterned to provide a number of discrete, single-domain magnetic islands (usually one island per bit) separated from each other. The increased magnetic volume of BPM helps to overcome the super-paramagnetic limit for conventional media. In addition, a reduction of jitter noise is observed via the pre-patterned bits.

As is known, magnetic recorders used with hard drives incorporate a variety of magnetic devices having magnetic features. Examples of such magnetic devices include poles, yokes, coils and contact plugs. Magnetic random access memory (MRAM) incorporates magnetic features for magnetic storage cells. In contrast to dynamic random access memory, which requires a continuous supply of electricity, MRAM is a solid-state, non-volatile memory that uses magnetism rather than electrical power to store data.

When used with magnetic recorders and MRAM cells, magnetic features of corresponding magnetic devices are required to be small in size, e.g., generally smaller than conventional semiconductor features. The magnetic features, particularly in BPM, need to have accurate dimensions. In addition, roughness and endpoint control are important considerations in fabricating magnetic devices. A smooth surface is necessary to enable magnetic head fly on the media, and small head spacing (HMS) is crucial for high linear density. Small HMS is controlled by endpoint detection. However, due to their small sizes, the magnetic features can be difficult to fabricate consistently. Fabrication of magnetic features for magnetic storage devices typically includes depositing and patterning various layers of material, and subsequently removing excess material via polishing techniques, such as chemical-mechanical polishing (CMP).

CMP is often used to remove surface topography in order to achieve planar surfaces suitable for photolithographic patterning of complex patterns. Material is removed during a CMP process by a combination of chemical etching and mechanical abrasion. CMP processes typically have a material removal rate of 300-500 nanometers (nm) per minute under normal process conditions. Removal generally continues until an endpoint is reached, which is theoretically the point at which all of the excess material is removed, with a smooth planar surface remaining. Planarized surfaces are needed for creating magnetic devices for magnetic recorders and MRAM cells, and for subsequent photolithography steps.

As is known, CMP can be used to effectively polish hard-filling materials; however, it is often difficult to control the endpoint. The endpoint can be determined by a variety of techniques. For example, prior CMP processes have incorporated instruments to measure changes in the surface optical reflectivity, changes in the surface temperature, and changes in eddy currents induced through the layers. More recently, stop layers have been disposed on the magnetic features to help indicate the endpoint. However, even when using the above-described CMP endpoint detection techniques, difficulties still exist in detecting endpoints in a timely fashion. This is generally due to the high rate of the CMP process. Consequently, these techniques continue to be subject to variations with respect to endpoint detection, which leads to reduced consistency between wafer thicknesses. In addition, when using CMP, magnetic portions of the magnetic features are often subjected to planarization. Thus, while using CMP offers an effective (can polish hard-filling materials) and efficient (high rate of material removal) approach, there exists a need for a planarization process that balances the benefits of CMP, while enabling reliable and consistent sizing of the magnetic devices. In addition, there is a need for a magnetic feature that is not susceptible to planarization of the magnetic portions of the magnetic feature. The present invention is directed to addressing these needs.

### SUMMARY OF THE INVENTION

In accordance with an aspect of the present invention, a magnetic device is provided having a magnetic feature for use in magnetic recorders and magnetic random access memory cells. The magnetic feature includes a plurality of magnetic portions comprising a magnetic material, a stop layer portion disposed above each magnetic portion, and a region of non-magnetic material adjacent to the magnetic portions and the stop layer portions. The stop layer portions define planar upper boundaries for the magnetic portions and an endpoint in planarization of the magnetic feature.

In accordance with another aspect of the present invention, a method of forming a magnetic feature is provided. The method includes forming a plurality of magnetic portions, disposing a stop layer portion above each magnetic portion to define an upper boundary for each magnetic portion, depositing non-magnetic material over the magnetic portions and stop layer portions so that an isolation layer is formed adjacent to the magnetic portions and stop layer portions and so that an excess layer is formed above the isolation layer, and planarizing the excess layer to dimensionally define the magnetic feature, wherein the planarizing involves two stages using two different processes. In some embodiments, a first stage comprises planarizing a significant portion of the excess layer by chemical-mechanical polishing and a second stage comprising planarizing a remainder portion of the excess layer by dry etching until the stop layer portions are reached.

These and various other features and advantages will be apparent from a review of the following detailed description and the accompanying drawings.

### BRIEF DESCRIPTION OF THE DRAWINGS

FIG. 1 is a top plane-view illustrating a magnetic recorder in accordance with certain embodiments of the present invention.

FIG. 2 is a top plane-view illustrating a magnetic device in accordance with certain embodiments of the present invention.

FIG. 3 is a sectional view illustrating a portion of a magnetic device having a magnetic feature in accordance with certain embodiments of the present invention.

FIGS. 4a-4d are sectional views illustrating a portion of a magnetic device having a magnetic feature, depicting how the magnetic feature is formed in accordance with certain embodiments of the present invention.

FIG. 5 is a sectional view illustrating a magnetic device having a magnetic feature, depicting the formed magnetic feature following a first stage of a planarization process in accordance with certain embodiments of the present invention.

FIG. 6 is a sectional view illustrating the magnetic device having a magnetic feature, depicting the formed magnetic feature following a second stage of a planarization process in accordance with certain embodiments of the present invention.

### DETAILED DESCRIPTION OF THE INVENTION

The following detailed description should be read with reference to the drawings, in which like elements in different drawings are numbered identically. Embodiments shown in the drawings are not necessarily to scale, unless otherwise noted. It will be understood that embodiments shown in the drawings and described herein are merely for illustrative purposes and are not intended to limit the invention to any embodiment. On the contrary, it is intended to cover alternatives, modifications, and equivalents as may be included within the scope of the invention as defined by the appended claims.

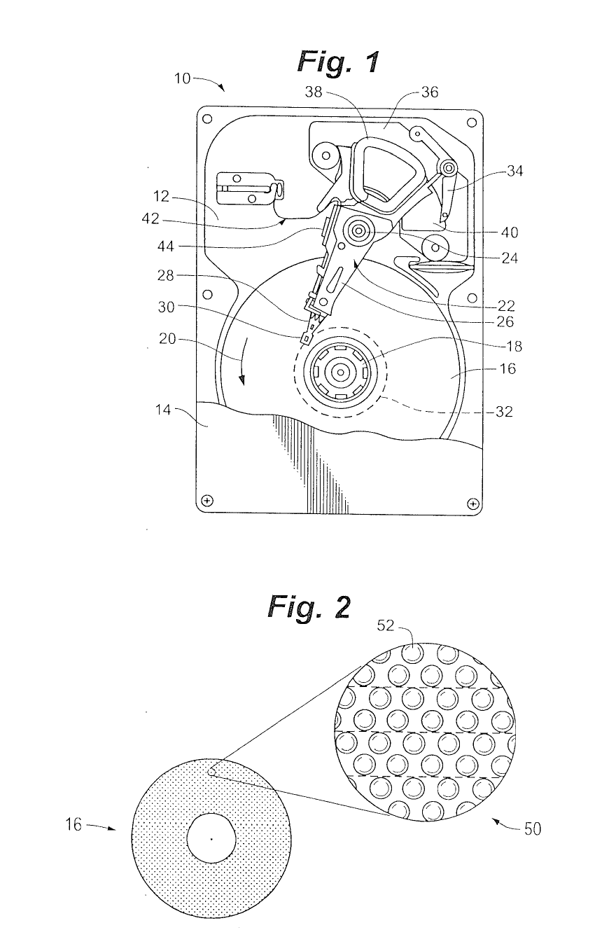

FIG. 1 shows a magnetic recorder 10. In the illustrated embodiment, the recorder 10 takes the form of a disk drive of the type used to interface with a host computer to magnetically store and retrieve user data. The disk drive includes various components mounted to a base 12. A top cover 14 (shown in partial cutaway fashion) cooperates with the base 12 to form an internal, sealed environment for the disk drive.

The magnetic recorder 10 includes magnetic storage media, or magnetic devices, for recording data. In the embodiment shown in FIG. 1, the devices takes the form of a plurality of axially-aligned, magnetic recording disks 16 mounted to a spindle motor (shown generally at 18) for rotating at a speed in a rotational direction 20. An actuator 22, which rotates about a bearing shaft assembly 24 positioned adjacent the disks 16, is used to write and read data to and from tracks (not designated) on the disks 16.

The actuator 22 includes a plurality of rigid actuator arms 26. Flexible suspension assemblies 28 are attached to the distal end of the actuator arms 26 to support a corresponding array of transducers 30 (e.g., read and/or write heads) with one transducer adjacent each disk surface. Each transducer 30 includes a slider assembly (not separately designated) designed to fly in close proximity to the corresponding surface of the associated disk 16. Upon deactivation of the disk drive 10, the transducers 30 come to rest on an outer stop 32 and a magnetic latch 34 secures the actuator 23.

A voice coil motor (VCM) 36 is used to move the actuator 22 and includes an actuator coil 38 and permanent magnet 40. Application of current to the coil 38 induces rotation of the actuator 22 about the pivot assembly 24. A flex circuit assembly 42 provides electrical communication paths between the actuator 22 and a disk drive printed circuit board assembly (PCBA) mounted to the underside of the base 12. The flex circuit assembly 42 includes a preamplifier/driver circuit 44 that applies currents to the transducers 30 to read and write data.

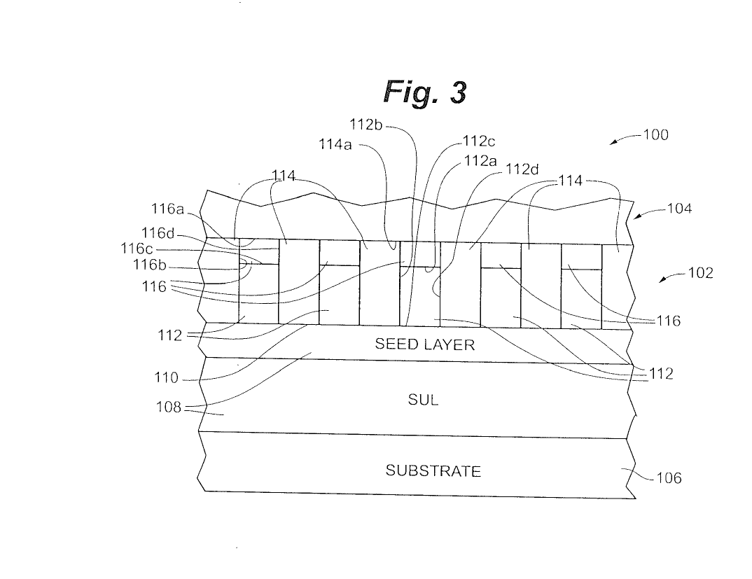

FIG. 2 shows a magnetic device in accordance with the concepts of the invention. While the device is exemplarily represented as a magnetic storage disk 16, the invention should not be limited to this embodiment, since those skilled in the art will appreciate that the magnetic device can just as well be represented as other forms and/or structures. The disk 16, illustrated with enlarged area, is a bit patterned medium (BPM), with exemplified data bit pattern 50 including a plurality of separate and discrete recording bits or dots 52 organized in a staggered bit pattern. As further detailed below with respect to FIG. 3, the disk 16 generally includes an underlying substrate with a magnetic feature with perpendicular anisotropy, along with one or more interlayers between the substrate and the magnetic feature according to some embodiments. The magnetic feature is patterned to form the discrete and separate dots 52 through, for example, lithographic patterning or self-organizing nanoparticle arrays. In some embodiments, the magnetic storage disk 16 is DC erased before it is mounted within the magnetic recorder.

The FIG. 3 cross-sectional view shows a portion of a magnetic device 100 having a magnetic feature 102 in accordance with certain embodiments of the present invention. The section of the magnetic device 100, representative from the disk 16 of FIG. 2, embodies a variety of multi-layer structures used in magnetic recorders (e.g., poles, yokes, coils, and contact plugs) and MRAM cells. In certain embodiments, the magnetic device 100 includes the magnetic feature 102, one or more overlaying layers 104, and an underlying substrate 106. In certain embodiments, as shown, the underlying substrate 106 may further underlie one or more interlayers 108 that are located between the substrate 106 and the magnetic feature 102. Examples of such interlayers 108, as illustrated, include a SUL (soft underlayer) and a seed layer. The underlying substrate 106 (along with any interlayers 108) represents the portion of the magnetic device 100 that is formed prior to the magnetic feature 102, and includes top surface 110, upon which the magnetic feature 102 is formed. The one or more overlaying layers 104 represent the portion of the magnetic device 100 that is disposed on top of the magnetic feature 102 after the magnetic feature 102 is formed. The overlaying layer(s) 104 and the underlying substrate 106 may provide a variety of characteristics for the magnetic device 100, such as additional magnetic properties or magnetic isolation.

As described above, the magnetic feature 102 is a multi-layer structure between the underlying substrate 106 (and any interlayers 108) and the overlaying layer(s) 104. The magnetic feature 102 includes magnetic portions 112, an isolation layer 114, and stop layer portions 116, where the stop layer portions 116 are used to detect an endpoint for the planarization process of the present invention, as further detailed below. Accordingly, using the planarization process embodied herein, the target thickness of the magnetic feature 102 can be accurately controlled and within wafer non-uniformity (WIWNU) is improved, while not subjecting the magnetic portions 112 to planarization.

The magnetic portions 112 collectively provide the magnetic feature 102 its magnetic properties, with each portion 112 existing in a region dimensionally defined by corresponding surfaces 112a-112d. Each of the surfaces 112b and 112d are disposed adjacent to the isolation layer 114. While the surfaces 112a through 112d depict each of the magnetic portions 112 as being rectangular, the magnetic portions 112 may alternatively be other shapes, such as trapezoidal. The magnetic portions 112 are derived of one or more high-magnetic-moment materials, such as a magnetic alloy. In certain embodiments, the magnetic portions 112 can be formed of magnetic alloys including iron, cobalt, nickel, and combinations thereof. Examples of suitable combinations, in certain embodiments, include nickel-iron, cobalt-iron, and nickel-cobalt-iron materials.

The dimensions of the magnetic portions 112 are generally small in comparison to semiconductor components. As previously discussed, small dimensions are warranted for use in magnetic recorders and MRAM cells. In certain embodiments, the magnetic portions 112 each have a thickness less than about 300 nm, with the thickness being the distance between the top surface 112a and the bottom surface 112c. Additionally, in certain embodiments, the magnetic portion 112 each have a width less than about 300 nm, with the width being the distance between the opposing side surfaces 112b and 112d. Each of the magnetic portions 112 also has a depth that may vary as individual needs may require, where the depth extends perpendicular to the sectional view of FIG. 3. For example, where the magnetic device 100 is a magnetic writer pole, the thickness and width of each of the magnetic portions 112 may each be about 300 nm, and the depth may extend the length of the writer pole. Due to the small dimensions of the magnetic portions 112, accurate control of the target thickness of the magnetic feature 102 is required.

As illustrated in FIG. 3, the bottom surface 112c of each magnetic portion 112 can contact the top surface 110 of the underlying substrate 106 (or the topmost layer of any interlayers 108). This allows a magnetic contact to exist between the magnetic portions 112 and the underlying substrate 106 (or topmost layer of any interlayers 108), if desired. Accordingly, the magnetic device 100 may be a variety of magnetic multi-level interconnecting structures. The isolation layer 114 is a non-magnetic layer and includes top surface 114a. The isolation layer 114 isolates the magnetic portion 112 in the lateral directions of the side surfaces 112b and 112d. The isolation layer 114 is derived from non-magnetic materials, such as oxide materials. In certain embodiments, the isolation layer 114 can be formed of aluminum oxide (Al₂O₃), silicon dioxide (SiO₂), SiOₓN_{y}, and combinations thereof. Al₂O₃ is an example of a particularly suitable material.

The isolation layer 114 may have a thickness as individual needs may require, where the thickness of the layer 114 is the distance between its top surface 114a and the top surface 110 of the underlying substrate 106 (or topmost layer of any interlayers 108). In certain embodiments, the isolation layer 114 has a thickness greater than the thickness of the magnetic portion 112 to account for the thickness of the stop layer portions 116 (e.g., the thickness of isolation layer 114 generally equals the combined thicknesses of one of the magnetic portions 112 and one of the stop layer portions 116).

The stop layer portions 116 are respectively disposed on the top surfaces 112a of the magnetic portions 112 with bottom surface 116c contacting therewith. Side surfaces 116b and 116d of each of the stop layer portions 116 are adjacent to the isolation layer 114. The stop layer 116 includes a top surface 116a and provides a means for detecting the CMP endpoint in planarizing the magnetic feature 102. This provides an accurate control of the target thickness of the magnetic feature 102. In certain embodiments, the stop layer portions 116 can have a thickness between about 2-100 nm, and more preferably between about 2-10 nm, where the thickness is the distance between their top surfaces 116a and the top surfaces 112a of corresponding magnetic portions 112.

In certain embodiments, the stop layer portions 116 are constructed of a highly magnetic material. In turn, the stop layer portions 116 assist in magnetically linking the magnetic portions 112 in a vertical direction through top surface 112a. In such embodiments, the stop layer portions 116 can be formed of magnetic alloys including iron, cobalt, nickel, and combinations thereof (e.g., nickel-iron, cobalt-iron, and nickel-cobalt-iron, etc.), thereby providing the highly magnetic property that is warranted. However, other like materials demonstrating similar magnetic property can be alternatively used as well.

Alternatively, in certain embodiments, the stop layer portions 116 are constructed of non-magnetic material. It should be appreciated that stop layer portions can also provide the benefits of protection and endpoint detection. In such embodiments, the stop layer portions 116 can be formed of diamond-like carbon, thereby providing the non-magnetic property that is warranted; however, other like materials demonstrating similar non-magnetic properties can be alternatively used as well.

As already exemplified above, it has been previously taught to use a stop layer to signal an endpoint with respect to a CMP process. However, as described above, this and other prior CMP endpoint detection techniques continue to be subject to variations with respect to detection of endpoints, which leads to reduced consistency between wafer thicknesses. Furthermore, the CMP process to date has lent itself to planarization of magnetic portions of the magnetic features. As a result, using CMP for its benefits (rapid polishing rate and use with hard-filling materials) has, to date, still provided less-than-ideal results.

The present invention takes advantage of the benefits of CMP planarization, while not being susceptible to its shortcomings. By initially using CMP planarization to remove a portion of one or more overlayers to the magnetic feature 102, a significant portion of the overlayer(s) can be removed in a timely manner. Subsequently, the remainder of the overlayer(s) can be removed via a dry etching (or ion milling) process. Such removal process of the overlayer(s) remainder enables efficient control in planarizing to the endpoint, while also enabling the entire planarization process to be timely performed as the etching is only directed at a remainder of the overlayer(s).

Constructing the magnetic feature 102 as provided in FIG. 3, particularly in locating the highly magnetic stop layer portions 116 on the magnetic portions 112, enables the combined planarization process of the present invention to be particularly effective. For example, many well-known CMP processes necessitate locating a non-magnetic stop layer adjacent the magnetic portions. As such, when the CMP process reaches the stop layer, it will simultaneously reach and planarize the magnetic portions, thereby planarizing the entire upper surface of the magnetic feature.

In contrast, the magnetic feature 102 of the present invention involves locating the magnetic stop layer portions 116 on the magnetic portions 112. Consequently, the magnetic portions 112 require no such planarizing. As described above, such magnetic portions 112, particularly with BPM, are precisely configured; as such, it is most effective to limit the amount of planarizing done with respect to the portions 112. In addition, the etching process is not required to planarize the hard material of the magnetic portions 112; to the contrary, upon reaching the stop layer portions 116, the process can be stopped. Thus, because the etching process is most effective with respect to non-hard materials, such can be achieved with the combined planarization process of the present invention.

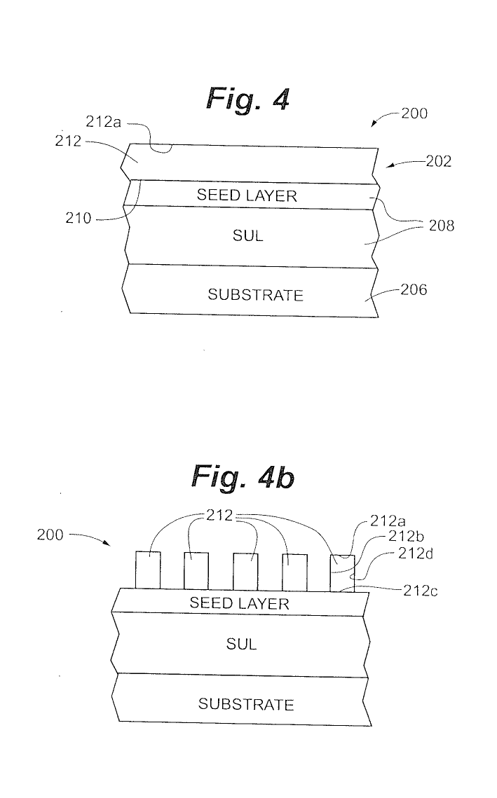

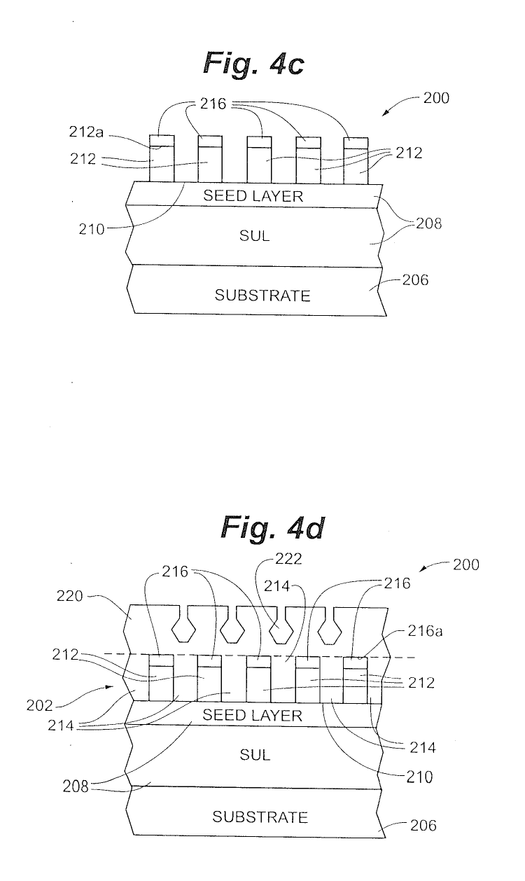

FIGS. 4a-4d provide cross-sectional views of a magnetic device having a magnetic feature, such as magnetic feature 102, depicting how the magnetic feature is formed in accordance with certain embodiments of the present invention. Corresponding to the figures, methods are provided of forming the magnetic feature 102, prior to the formation of the overlaying layer(s) 104. While only discussing the magnetic device 100 individually, it is understood that large numbers of magnetic devices, as described herein, are generally formed simultaneously on a wafer, and are subsequently separated.

FIG. 4a shows magnetic device 200, which is analogous to magnetic device 100, prior to the formation of magnetic feature 102. As illustrated, magnetic device 200 includes a magnetic feature 202 and an underlying substrate 206 at an initial stage of formation. Similar to that described above with respect to magnetic device 100, the underlying substrate 206 of the magnetic device 200, in certain embodiments, as shown, may further underlie one or more interlayers 208 (e.g., a SUL and a seed layer) that are located between the substrate 206 and the magnetic feature 202. The magnetic feature 202 is formed by first depositing a high-magnetic-moment material on a top surface 210 of the underlying substrate 206 (or topmost interlayer) to initially form a magnetic portion 212 as a layer. Material depositions referred to herein may be performed by conventional methods such as electroplating, sputtering, physical vapor deposition, or chemical vapor deposition. After deposition, the layer defining magnetic portion 212 has a thickness defined by the distance between top surface 212a and the top surface 210 of the underlying substrate 206 (or topmost interlayer).

After depositing the high-magnetic-moment material, a photoresist layer (not shown) may be deposited on top of surface 212a. A portion of the photoresist layer, which corresponds to magnetic portion 112 in FIG. 3, can be polymerized as desired to provide a mask layer. The remaining un-polymerized portion of the photoresist layer is then washed off. An etching process (e.g., ion beam etching) can then used to remove the unmasked portions of high-magnetic-moment material. The polymerized portion of the photoresist layer is then stripped to provide the magnetic portions 212, as depicted in FIG. 4b. As shown, each of the magnetic portions 212 has dimensions defined by surfaces 212a-212d. After the etching process, the magnetic portions 212 each have a width defined by the distance between corresponding surfaces 212b and 212d. Correspondingly, the portions of top surface 210 of underlying substrate 206 (or topmost interlayer) outside the magnetic portions 212 are exposed.

As shown in FIG. 4c, after the magnetic portions 212 are formed, stop layer portions 216 are disposed on the top surfaces 212a of each of the magnetic portions 212. As should be appreciated, such stop later portions 216 can be added to the magnetic portions 212 using any of a variety of deposition methods, such as sputtering, CVD, ion deposition, or the like. It should be appreciated that using such deposition methods may likely result in some material being deposited between the magnetic portions 212 and ending up on the underlying substrate 206 (or topmost interlayer). If the stop layer portions 216 were of a magnetic material, such deposition between the magnetic portions 212 can be limited by using any of a variety of methods. For example, in certain embodiments, a glancing angle deposition is used in depositing the stop layer portions 216. In such deposition, a general shadowing effect would result, which would stop the molecular or ion beam from reaching deep into the trenches between the magnetic portions 212. Consequently, resulting deposition would be found to only occur at upper regions between the magnetic portions 212, whereat fusion of the magnetic portions 212 may occur. Following the deposition process and prior to deposition of an isolation layer 214 (as described below), any of a number of methods, e.g., etching, can be used to open such fused regions.

After forming the stop layer portions 216 on the magnetic portions 212, non-magnetic material is deposited on the top surface 210 of the underlying substrate 206 (or topmost interlayer), the magnetic portion 212, and the stop layer portions 216 to form the isolation layer 214. After such deposition, the isolation layer 214 has a thickness defined by the distance between top surfaces 216a of the stop layer portions 216 and the top surface 210 of the underlying substrate 206 (or topmost interlayer), as shown in FIG. 4d. The other portion of the non-magnetic material lying above the top surfaces 216a of the stop layer portions 216 is deemed as an excess layer 220 of non-magnetic material. Such excess layer 220 also includes a plurality of valleys, noted by an indentation 220b correspondingly defined by the non-magnetic material over each gap between the magnetic portions 212.

Preferred dimensions and suitable materials for the magnetic portions 212, stop layer portions 216, and isolation layer 214 are described above with respect to FIG. 3 for magnetic portions 112, stop layer portions 116, and isolation layer 114, respectively. Suitable materials for each are also described above with respect to FIG. 3. Moreover, it is desirable that the material(s) used for excess layer 220 have a higher than average removal rate selectivity. This allows the combined CMP/etching processes to remove excess layer 220 at higher than average rates. Preferred thicknesses for the excess layer 220 may include those described with respect to FIG. 3 for the isolation layer 114. Generally, such thicknesses provide an adequate polish time to remove the excess layer 220 above the stop layer portions 216 using both CMP and etching as provided for in the embodiments of the present invention.

After being formed as shown in FIG. 4d, a first stage of the planarization process is started. Specifically, the magnetic feature 202 is initially polished via a CMP process to planarize magnetic feature 202 to the point where a significant portion of the excess layer 220 of non-magnetic material is removed. In certain embodiments, this significant portion of the excess layer 220 involves the material defining the indentations 222. During the CMP process, the portion of the excess layer 220 is removed by a combination of chemical etching and abrasion by the polishing pad of the CMP apparatus (not shown). When the polishing pad reaches the point at which it contacts all non-magnetic material (i.e., so as to have completely removed the material defining the indentations 222), increased polishing friction is induced on the polishing pad (i.e., removal rate decreases), thereby triggering the CMP apparatus to stop. As should be appreciated, the CMP apparatus can be so configured so as to stop upon sensing this increased friction due to the encounter of all non-magnetic material. In turn, stopping the CMP at this point results in the magnetic feature 202 shown in FIG. 5.

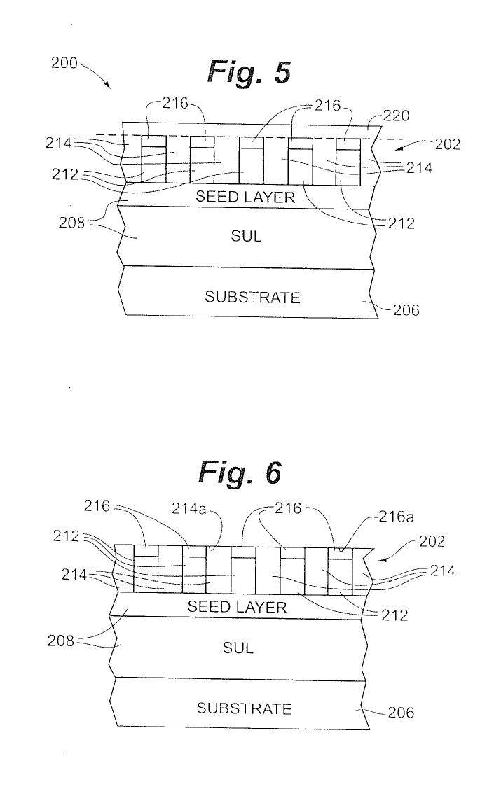

Following completion of the first stage of the planarization process, a second stage is started. Accordingly, the magnetic feature 202 is planarized via a dry etching process to the point where the remainder of the excess layer 220 is removed, thereby forming the magnetic feature 202 shown in FIG. 6, which is similar to the magnetic feature 102 shown in FIG. 3. Such etching process results in contact with the stop layer portions 216, thereby signaling an end to the combined CMP/etching planarization of the magnetic feature 202. As previously mentioned, it is preferable that the thickness of the isolation layer 214 is generally equal to the combined thicknesses of the magnetic portions 212 and their corresponding stop layer portions 216. Accordingly, the etching process can be stopped upon removing the excess layer 220, which leads to the etching process contacting the stop layer portions 216. As a result, the target thickness of the magnetic feature 202 is accurately controlled, and WIWNU is improved from conventional planarization techniques.

As described herein, confirmation of endpoints, even when implementing stop layers, can be detected by incorporating instruments to measure changes in surface optical reflectivity, changes in surface temperature, and changes in electrical currents (i.e., eddy currents) induced through the layers. However, given the control by which the dry etching process avails one to recognize contact with the stop layer portions 216, no such instruments are necessitated by the described process. In turn, the combined CMP/etching planarization process is more effective and more efficient than other known processes requiring such indicators.

Through the use of the combined CMP/etching planarization process, the planization endpoint can be accurately detected, which minimizes thickness variations induced by under-polishing and over-polishing. FIG. 6 depicts magnetic device 200 with magnetic feature 202 after the endpoint has been detected and etching has been stopped. The result is a smooth planar surface defined by top surfaces 216a of stop layer portions 216 and top surface 214a of isolation layer 214. As a result, the thickness of magnetic feature 202 is also accurately determined and may be consistently replicated through this method. Subsequently, overlying layer(s) 104 may be formed to provide magnetic device 100 shown in FIG. 3.

As described above, by detecting the planarization endpoint via the combined CMP/etching planarization process, the target thickness of the magnetic feature is accurately controlled, and WIWNU is improved. This allows a magnetic device having the magnetic feature to be fabricated accurately and consistently for use in magnetic recorders and MRAM cells. Although the present invention has been described with reference to preferred embodiments, workers skilled in the art will recognize that changes may be made in form and detail without departing from the spirit and scope of the invention.

Although the present invention has been described in considerable detail above with reference to certain disclosed embodiments, the disclosed embodiments are presented for purposes of illustration and not limitation. The implementations described above and other implementations are within the scope of the following claims.

What is claimed is:

1. A magnetic device having a magnetic feature, the magnetic feature comprising:
a plurality of magnetic portions comprising a magnetic material;
a stop layer portion disposed above each magnetic portion; and
a region of non-magnetic material adjacent to the magnetic portions and stop layer portions,
wherein the stop layer portions define planar upper boundaries for the magnetic portions as well as an endpoint in planarization of the magnetic feature.

2. The magnetic feature of claim 1, wherein each of the magnetic portions has a width of less than about 300 nanometers and a height of less than about 300 nanometers.

3. The magnetic feature of claim 1, wherein each of the stop layer portions are disposed on top surfaces of the magnetic portions.

4. The magnetic feature of claim 3, wherein the stop layer portions are formed of a magnetic material.

5. The magnetic feature of claim 3, wherein the stop layer portions are formed of a material that assists in magnetically linking the magnetic portions in a vertical direction.

6. The magnetic feature of claim 3, wherein each of the stop layer portions has a height of between about 2 nanometers and about 100 nanometers.

7. The magnetic feature of claim 6, where each of the stop layer portions has a height of between about 2 nanometers and about 10 nanometers.

8. The magnetic feature of claim 1, wherein the stop layer portions and the non-magnetic material region have substantially planar top surfaces.

9. The magnetic feature of claim 1, wherein the non-magnetic material region has a height that is substantially equal to combined heights of one of the magnetic portions and one of the stop layer portions.

10. A method of forming a magnetic device having a magnetic feature, the method comprising:
forming a plurality of magnetic portions;
disposing a stop layer portion above each magnetic portion;
depositing non-magnetic material over the magnetic portions and stop layer portions so that an isolation layer is formed adjacent to the magnetic portions and stop layer portions and so that an excess layer is formed above the isolation layer; and
planarizing the excess layer to dimensionally define the magnetic feature,
wherein the planarizing step involves two stages using two different processes.

11. The method of claim 10, wherein a first of the two stages comprises planarizing a significant portion of the excess layer by chemical-mechanical polishing.

12. The method of claim 11, wherein indentations are formed in the excess layer above gaps between the magnetic portions, wherein one indentation is formed above each gap, and wherein the significant portion of the excess layer comprises a portion of the excess layer defining the indentations.

13. The method of claim 11, wherein a second of the two stages comprises planarizing a remainder portion of the excess layer by etching until the stop layer portions are reached.

14. The method of claim 10, wherein each of the stop layer portions are disposed on top surfaces of the magnetic portions.

15. A method of forming a magnetic device having a magnetic feature, the method comprising:
forming a plurality of magnetic features;
disposing a stop layer portion above each magnetic portion;
depositing non-magnetic material over the magnetic portions and stop layer portions so that an isolation layer is formed adjacent to the magnetic portions and stop layer portions and so that an excess layer is formed above the isolation layer, the isolation layer and stop layer portions having substantially planar top surfaces; and
planarizing the excess layer to dimensionally define the magnetic feature.

16. The method of claim 15, wherein the planarizing involves two stages using two different processes.

17. The method of claim 16, wherein a first of the two stages comprises planarizing a significant portion of the excess layer by chemical-mechanical polishing.

18. The method of claim 17, wherein indentations are formed in the excess layer above gaps between the magnetic portions, wherein one indentation is formed above each gap, and wherein the significant portion of the excess layer comprises a portion of the excess layer defining the indentations.

19. The method of claim 17, wherein a second of the two stages comprises planarizing a remainder portion of the excess layer by etching until the stop layer portions are reached.

20. The method of claim 15, wherein each of the stop layer portions are disposed on top surfaces of the magnetic portions.
